(19) United States
(12) Patent Application Publication
(10) Pub. No.: US 2026/0351054 A1
(43) Pub. Date: Nov. 5, 2026

(54) VEHICLE TRAIL RANGE ESTIMATION

(71) Applicant: FCA US LLC, Auburn Hills, MI (US)

(72) Inventor: Spenser T. Foster, Auburn Hills, MI (US)

(21) Appl. No.: 19/195,133

(22) Filed: Apr. 30, 2025

(51) Int. Cl. G07C 5/00; B60L 58/12; G01C 21/20; G07C 5/04; G07C 5/06

(52) U.S. Cl. CPC G07C 5/004; B60L 58/12; G01C 21/20; G07C 5/04; G07C 5/06; B60L 2240/545; B60L 2240/547; B60L 2240/60

(57) ABSTRACT

An off-road trail range estimation (TRE) system for an electrified vehicle having an electrified powertrain including an electric motor powered by a high voltage (HV) battery system includes a controller configured to receive a navigational destination that includes a navigational route with an off-road trail, receive, from a trail database, information about the off-road trail, receive data from the HV battery system indicating status information of the HV battery system utilized to estimate a vehicle electric range, determine vehicle operating conditions for traveling the off-road trail, based on the trail database information, and determine an estimated vehicle electric trail range based on the trail database information and the received data from the HV battery system, to thereby determine if the electrified vehicle has enough range to complete the off-road trail.

### FIELD

The present application generally relates to electrified vehicles and, more particularly, to range prediction or estimation techniques for electrified vehicles.

### BACKGROUND

Electrified vehicles (EVs) include at least one electric traction motor powered by a high voltage battery system, which is capable of storing a finite amount of energy. Range anxiety is a driver's perception of the risk of running out of propulsive or traction energy, and remains a key obstacle in the way of wide marketability of EVs. To reduce range anxiety, current EVs feature a standard range estimation that largely relies on past data and recent driving history. However, such range estimations are insufficient for off-road or overland (trail) events due to their greatly varying driving conditions and propulsion system demands. Many trails do not (and will not) have the infrastructure needed for charging EVs. If battery power runs out during the off-road event, EV retrieval is often very difficult due to the weight and complexity of the vehicle. Accordingly, while such conventional EV range estimation techniques do work for their intended purpose, there exists an opportunity for improvement in the relevant art.

### SUMMARY

According to one example aspect of the invention, an off-road trail range estimation (TRE) system for an electrified vehicle having an electrified powertrain including an electric motor powered by a high voltage (HV) battery system is provided. In one exemplary implementation, the TRE system includes a controller having one or more processors and a non-transitory computer-readable storage medium having a plurality of instructions stored thereon, which, when executed by the one or more processors, cause the one or more processors to perform operations comprising: receive a navigational destination that includes a navigational route with an off-road trail; receive, from a trail database, information about the off-road trail; receive data from the HV battery system indicating status information of the HV battery system utilized to estimate a vehicle electric range; determine vehicle operating conditions for traveling the off-road trail, based on the trail database information; and determine an estimated vehicle electric trail range based on the trail database information and the received data from the HV battery system, to thereby determine if the electrified vehicle has enough range to complete the off-road trail.

In addition to the foregoing, the described TRE system may include one or more of the following features: wherein the received data includes a state of charge (SOC) of the HV battery system, a state of health (SOH) of the HV battery system, a temperature of the HV battery system, and a capacity and voltage of the HV battery system; wherein the received information from the trail database includes a trail distance, an estimated trail speed, elevation changes of the off-road trail, and grades of the off-road trail; and wherein the controller is further configured to receive user input indicating trail conditions the driver expects to encounter, wherein the determined estimated vehicle electric trail range is further based on the received user input.

In addition to the foregoing, the described TRE system may include one or more of the following features: wherein the controller is further configured to prompt a user for their intended vehicle cabin needs during travel on the off-road trail, wherein the determined estimated vehicle electric trail range is further based on the intended vehicle cabin needs; wherein the intended vehicle cabin needs include whether or not an HVAC system of the electrified vehicle will be utilized during travel on the off-road trail, and whether or not a vehicle roof will be removed during travel on the off-road trail; and wherein the controller is further configured to receive vehicle data indicating status information of the electrified vehicle utilized to estimate a vehicle electric range, wherein the determined estimated vehicle electric trail range is further based on the received vehicle data.

In addition to the foregoing, the described TRE system may include one or more of the following features: wherein the received vehicle data includes a temperature of the electric motor, a tire pressure of a plurality of wheels of the electrified vehicle, electrical loads of one or more accessories of the electrified vehicle, and propulsion system needs of the electrified vehicle based on a selected vehicle drive mode; and wherein the controller is further configured to receive historical drive cycle data, wherein the determined estimated vehicle electric trail range is further based on the received historical drive cycle data.

In addition to the foregoing, the described TRE system may include one or more of the following features: wherein the controller is further configured to display the estimated vehicle electric trail range on a human machine interface (HMI) of the electrified vehicle, and provide a notification on the HMI if the estimated vehicle electric trail range is insufficient to enable the electrified vehicle to complete travel of the off-road trail; and wherein the controller is further configured to determine a remaining range estimation for the electrified vehicle after travel on the off-road trail is complete, determine if a vehicle charging location is within the determined remaining range estimation, and provide a notification if the determined remaining range estimation is insufficient to enable the electrified vehicle to reach the vehicle charging location.

In accordance with another example aspect of the invention, a trail range estimation method for an electrified vehicle having an electrified powertrain including an electric motor powered by a high voltage (HV) battery system, and a trail range estimation (TRE) system including a controller having one or more processors and a non-transitory computer-readable storage medium is provided. In one exemplary implementation, the method includes receiving, by the controller, a navigational destination that includes a navigational route with an off-road trail; receiving, by the controller and from a trail database, information about the off-road trail; receiving, by the controller, data from the HV battery system indicating status information of the HV battery system utilized to estimate a vehicle electric range; determining, by the controller, vehicle operating conditions for traveling the off-road trail, based on the trail database information; and determining, by the controller, an estimated vehicle electric trail range based on the trail database information and the received data from the HV battery system, to thereby determine if the electrified vehicle has enough range to complete the off-road trail.

In addition to the foregoing, the described method may include one or more of the following features: wherein the received data includes a state of charge (SOC) of the HV battery system, a state of health (SOH) of the HV battery system, a temperature of the HV battery system, and a capacity and voltage of the HV battery system; wherein the received information from the trail database includes a trail distance, an estimated trail speed, elevation changes of the off-road trail, and grades of the off-road trail; and receiving, by the controller, user input indicating trail conditions the driver expects to encounter, wherein the determined estimated vehicle electric trail range is further based on the received user input.

In addition to the foregoing, the described method may include one or more of the following features: prompting, by the controller, a user for their intended vehicle cabin needs during travel on the off-road trail, wherein the determined estimated vehicle electric trail range is further based on the intended vehicle cabin needs; receiving, by the controller, vehicle data indicating status information of the electrified vehicle utilized to estimate a vehicle electric range, wherein the determined estimated vehicle electric trail range is further based on the received vehicle data; and receiving, by the controller, historical drive cycle data, wherein the determined estimated vehicle electric trail range is further based on the received historical drive cycle data.

In addition to the foregoing, the described method may include one or more of the following features: displaying, by the controller, the estimated vehicle electric trail range on a human machine interface (HMI) of the electrified vehicle, and providing, by the controller, a notification on the HMI if the estimated vehicle electric trail range is insufficient to enable the electrified vehicle to complete travel of the off-road trail; and determining, by the controller, a remaining range estimation for the electrified vehicle after travel on the off-road trail is complete, determining, by the controller, if a vehicle charging location is within the determined remaining range estimation, and providing, by the controller and the HMI, a notification if the determined remaining range estimation is insufficient to enable the electrified vehicle to reach the vehicle charging location.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example trail range estimation system according to the principles of the present application;

FIG. 2 is an example schematic diagram of the trail range estimation system of FIG. 1, according to the principles of the present application; and

FIG. 3 illustrates a flow diagram of an example trail range estimation method for an electrified vehicle, according to the principles of the present application.

### DESCRIPTION

As previously discussed, high voltage (HV) battery systems are limited to storing a finite amount of energy, and the corresponding range anxiety remains a key obstacle in the way of wide marketability of electrified vehicles. While conventional range estimation techniques may help reduce range anxiety, they are often inaccurate, particularly during off-roading or overlanding events where greatly varying driving conditions and propulsion system demands occur.

Accordingly, described herein are systems and methods for estimating electric vehicle range while traversing off-road trails to provide the driver with confidence that their vehicle has enough range to complete the off-road trail without becoming stranded. In one example, the system is accessible through a vehicle human machine interface (HMI) such as a computer application on the infotainment unit or through an “off-road” menu on a vehicle screen. The system may also interface with built-in computer applications either through the vehicle or a portable electronic device (e.g., smart phone). The system is configured to utilize various inputs like recent driving data/habits, ambient temperature, HV battery temperature, electric motor temperature, tire pressure, estimated trail speed, trail distance, elevation change, battery state of charge (SOC), accessory loads, expected propulsion system needs (drive modes), etc. in order to predict the expected off-road range and whether a driver could expect to complete a trail with their EV.

As such, the system is a Trail Range Estimator (TRE) configured to provide a user with predictive range estimation based on their planned trip that includes off-road trails. Before leaving the trail head, the user is able to input the trail conditions they expect to encounter. If available, a user may be able to pull trail data from an associated computer application or database. The trail data may provide important information such as trail distance and elevation changes. The system may also prompt the user for their intended cabin needs, for example if they will be using HVAC or if they will be driving open air (e.g., vehicle top removed). The system will receive all trail and user info/data inputs combined with predetermined vehicle data such as, for example, battery SOC, propulsion system demands for off-road drive mode (AWD, 4WD, etc.), battery temperature, ambient temperature, electric motor temperature, tire pressure, accessory loads, etc. to predict the expected off-road range. If the system determines the vehicle cannot complete the entire trip on the current battery charge, the system may then provide a notification to the user and/or provide alternative route(s). The system may also calculate a minimum SOC required to complete the trail if that is a limiting factor.

With this information, the user can choose an off-road adventure with more confidence. As such, the TRE system factors in critical information that is not used by standard vehicle range estimation. The system does not rely entirely on a running average of efficiency and power consumption to predict future range. Instead, the system accounts for unique driving scenarios of off-road trail driving and leverages GPS-based off-road databases (e.g., computer applications) to predict if a user will complete trails with battery electric vehicles.

In the systems described herein, estimated range is an indication of the distance the vehicle can be expected to be driven using only electric power, electric power with a gasoline/diesel engine power source, or electric power with hydrogen fuel cell power. In general, the electric power calculation is based on off-road trail factors, vehicle system factors, and driving behavior factors. Example off-road trail factors include, but are not limited to, estimated trail speed, trail distance, elevation change, and ambient temperature. Example vehicle system factors include, but are not limited to, HV battery temperature, HV battery SOC, HV battery capacity, tire pressure, electric motor temperature, vehicle accessory loads (e.g., HVAC loads, low voltage loads, etc.), expected propulsion system needs (e.g., based on user-selected drive mode), and the amount of regenerative braking. Example driving behavior factors include historical driving data (e.g., propensity for hard accelerations, driving under posted speed limits, etc.). However, these factors may include any other systems/events that pull energy from or put energy into the HV battery.

For vehicles with fuel engines for range extension, the range calculation is based on equivalent electric-fuel energy remaining in the fuel tank, measured in Watt*Hours remaining, instantaneous fuel consumption, engine speed, and torque output. For vehicles with hydrogen fuel cells for range extension, the range calculation is based on equivalent hydrogen level, actual power produced by the fuel cell system, and actual hydrogen consumption. The overall range function may also use vehicle performance characteristics such as drag coefficient, vehicle mass, drive modes, etc. to determine the overall range of the vehicle.

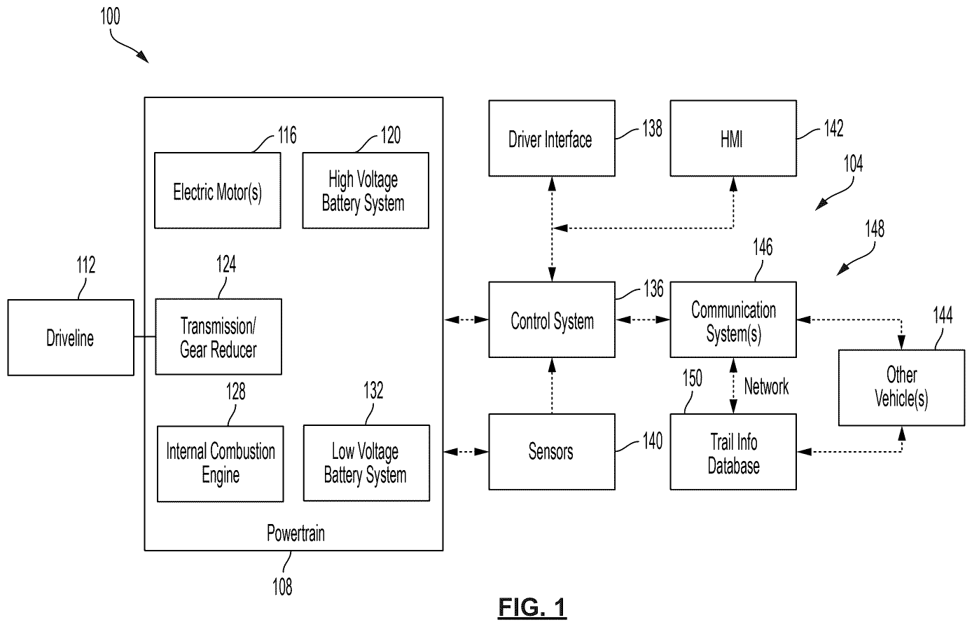

With initial reference to FIG. 1, a functional block diagram of an electrified vehicle 100 having an example trail range estimation (TRE) system 104 according to the principles of the present application is illustrated. The electrified vehicle 100 could be any suitable type of electrified vehicle, including, but not limited to, battery electric vehicle (BEV) or a hybrid electric vehicle (HEV). The electrified vehicle 100 comprises an electrified powertrain 108 configured to generate and transfer drive torque to a driveline 112 for vehicle propulsion. The electrified powertrain 108 includes one or more electric traction motors 116 each configured to generate mechanical drive torque using energy (e.g., electrical current) supplied by a high voltage (HV) battery system 120. For example, an inverter (not shown) could be used to convert the direct current (DC) from the high voltage battery system 120 to three-phase alternating current (AC) to power the electric traction motor(s) 116. A transmission 124 (e.g., an automatic transmission) is configured to transfer the drive torque from the electrified powertrain 108 to the driveline 112.

In some configurations, the electrified powertrain 108 may also include an internal combustion engine 128 configured to combust a mixture of air and fuel (gasoline, diesel, etc.) to generate mechanical torque for vehicle propulsion and/or conversion to electrical energy, such as for recharging battery system 120. It will be appreciated that the electrified powertrain 108 could alternatively include another energy generator, such as a hydrogen or other suitable fuel cell system (a fuel cell electric vehicle, or FCEV). A low voltage battery system 132 (e.g., a 12-volt (V) battery) is configured to power low voltage components and accessory loads of the electrified vehicle 100.

A control system 136 is configured to control the electrified powertrain 108, including controlling the electrified powertrain to generate an amount of drive torque to satisfy a torque request provided by a driver/operator via a driver interface 138 (e.g., an accelerator pedal). A plurality of sensors 140 are configured to measure operating parameters of the electrified vehicle 100, such as, but not limited to, speeds/accelerations, pressures, temperatures, and electrical parameters (voltage, current, state of charge, etc.). The sensors 140 may also include other vehicle systems, such as a GPS navigation/maps system. The control system 136 is also in signal communication with a human machine interface (HMI) 142 such as, for example, an instrument panel cluster or other display configured to display information to the driver.

The control system 136 is also configured to communicate with other devices/systems (e.g., other vehicles 144) using one or more communication systems 146 each configured for communication via a particular communication network or medium 148. For example, the communication systems 146 could include a long-range cellular communication transceiver, a short-range wireless communication (e.g., Bluetooth) transceiver. The network 148 can be any suitable communication network including, for example, a satellite network, a cellular network (3G, 4G LTE, 5G, etc.), a computing network (local area network, the internet, etc.), or some combination thereof.

One particular communication by the control system 136 via the communication system(s) 146 is with a set of one or more databases 150 that store/analyze data about off-road trails such as, for example, trail distance, elevation change, etc. The databases 150 may be owned and operated by a particular vehicle original equipment manufacturer (OEM) or other entity and may only be accessible to authorized users, such as through a computer application. The databases 150 may also include information received from other vehicles 144 that have previously traveled the off-road trails (e.g., power consumption to complete the trail).

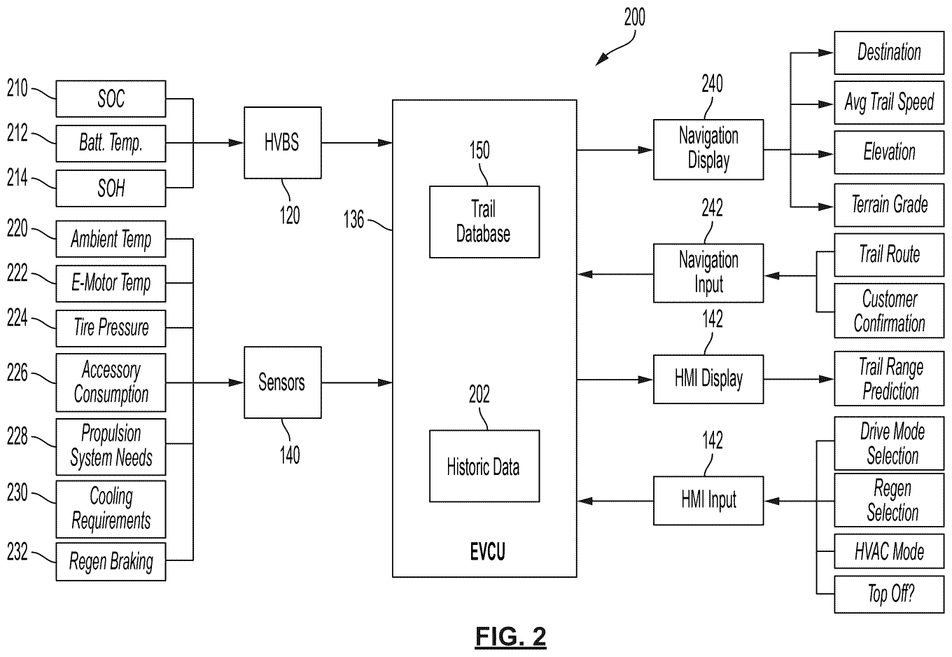

Referring now to FIG. 2, an example schematic diagram 200 of the TRE system 104 is presented according to the principles of the present application. As shown, the TRE system 104 includes the supervisory controller 136, which is in signal communication with and is configured to coordinate interaction between powertrain modules, sensors, and other electrical and electronic modules or components. In the example embodiment, the supervisory controller 136 includes or is in signal communication with the HV battery system 120, sensors 140, HMI 142, trail database 150, and historic data 202 to receive various inputs for estimating the trail range of vehicle 100.

In the example embodiment, the HV battery system 120 provides one or more of the following inputs: a HV battery SOC 210, a HV battery temperature 212, and a HV battery state of health (SOH) 214. For example, the HV battery SOC 210 provides information related to remaining capacity in the HV battery, the HV battery temperature 212 is used to determine HV battery efficiency, and the HV battery SOH 214 provides information related to battery age and deterioration.

The sensors 140 provide one or more of the following inputs: an ambient temperature 220, a temperature 222 of electric motor(s) 116, a tire pressure 224 of the vehicle wheels (not shown), accessory loads 226, propulsion system needs 228 (e.g., driver selected drive mode), cooling system requirements 230, and regenerative braking 232. For example, the ambient temperature 220 is used to predict if propulsion system cooling will be needed during the route (e.g., to maintain proper battery and motor temperatures), the motor temperature 222 provides information related to energy consumption and efficiency, the tire pressure 224 provides an impact rolling resistance that effects energy consumption, the accessory loads 226 provide information indicating vehicle component power consumption and state, propulsion system needs 228 provide information related to HV power consumption based on the user-selected drive mode (e.g., AWD, 4WD, etc.), cooling system requirements 230 provide information related to HV power consumption based on cooling requirements for vehicle components (e.g., cool components on a hot day), and regenerative braking 232 provides information related to HV power gained from a regenerative braking system (not shown).

The HMI 142 is a user interface such as the instrument cluster, radio, or other visual/touch interfaces. The HMI 142 is configured to receive input signals from supervisory controller 136, for example, indicating an SOC display, an SOC prediction, a vehicle range display, a vehicle range prediction, and a vehicle power consumption. The HMI 142 is configured to provide input signals to the supervisory controller 136, for example, indicating a drive mode selection (e.g., sport, eco, etc.), regen selection (e.g., regenerative braking active), e-coast selection (e.g., e-coast on/off), and a maximum charge selection (e.g., 70%, 90%, 100%), an HVAC mode (e.g., on/off), and whether the vehicle will be traveling in an open air configuration (e.g., top off).

The trail database 150 may be part of the HMI 142 and also may include a navigation display 240 and navigation input 242 associated with a GPS/maps system, which could include a global navigation satellite system (GNSS) transceiver (not shown) configured to determine a precise geo-location of the vehicle 100 (e.g., precise coordinates of the vehicle 100). The GPS/maps system could also be configured to determine and localize the position of the vehicle 100 relative to a map, such as a high-definition (HD) map. Map data could be stored remotely (e.g., at a remote server), locally (e.g., at the controller 136), or some combination thereof. The map data includes, among other things, a plurality of road/trail segments each having varying road/trail attributes (length, average speed, curvature, elevation, grade, etc.). A navigational route for the vehicle 100 could include a plurality of these road segments from a start point to a desired end point. This route could be user-specified (e.g., via a driver input) or based on historical data/patterns, such as when/where the driver normally drives the vehicle 100.

The navigation display 240 is configured to receive input signals from supervisory controller 136 indicating information such as, for example, a destination, traffic data, speed limits, elevation, terrain (grade), and weather conditions. This information may be displayed to the user, for example, on HMI 142. Navigation input 242 is configured to provide input signals indicating a selected route as well as user confirmation.

The historic data 202 includes, for example, historical drive cycle data (e.g., vehicle loading, energy consumption per mile, etc.) of the driver for energy consumption calculation within the supervisory controller 136.

The supervisory controller 136 then evaluates or utilizes one or more of the previously described inputs, for example, using a control algorithm (CA). Based on these unique inputs, the controller 136 predicts a range estimation for traversing a selected off-road trail. If the current HV battery SOC indicates the vehicle 100 will be unable to complete the selected off-road trail with enough range to then travel to a charging station/location, the controller 136 will provide a warning/notification to the vehicle user.

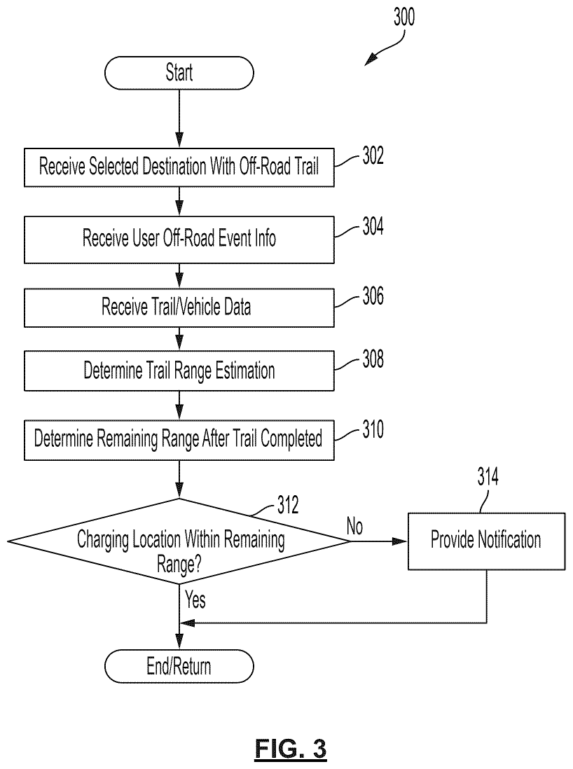

Referring now to FIG. 3, a flow diagram of an example trail range estimation method 300 for an electrified vehicle according to the principles of the present application is illustrated. While the method 300 specifically references the electrified vehicle 100 and its components for illustrative/descriptive purposes, it will be appreciated that the method 300 could be applicable to any suitably configured electrified vehicle.

In the example embodiment, the method begins at 302 where the supervisory controller 136 (“control”) receives a selected destination with a route that includes an off-road/overland trail. For example, this may be input into the HMI 142 by a user or received via the trail database 150. Optionally, at 304, control may query the vehicle user via the HMI 142 to request additional information about the off-road event. In general, the controller 136 queries one or more user-selected conditions that affect vehicle range on the selected trail route. For example, control may query whether the off-road event will be completed with the HVAC system on/off or if the vehicle will be in an open-air condition (e.g., removable top is off).

At 306, control receives inputs from one or more of the HV battery system 120, sensor 140, HMI 142, trail database 150, and historic data 202, as previously described. At 308, based on the received inputs (from 306 and optionally 304), control determines a trail range estimation for the vehicle 100. At 310, control determines a remaining range estimation for the vehicle 100 once the off-road trail is completed. At 312, control determines if there is a charging station/location within the remaining range estimation. If yes, control ends or returns to 302. If no, control provides a notification to the driver (e.g., on HMI 142) indicating the vehicle does not have enough HV battery capacity to complete the off-road trail and reach a charging station/location. Control may also provide a notification indicating how much HV battery capacity would be required to complete the off-road trail, for example, to enable the driver to prepare for a particular trail and ensure the HV battery has enough charge. Control then ends or returns to 302.

It will be appreciated that the term “controller” or “module” or the like as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

1. An off-road trail range estimation (TRE) system for an electrified vehicle, the TRE system comprising:
an electrified powertrain including at least one electric traction motor;
a high voltage (HV) battery system configured to power the at least one electric traction motor;
a plurality of sensors configured to measure operating parameters of the electrified vehicle including parameters of the HV battery system;
a vehicle communications system configured to communicate with a trail database configured to store and analyze data about off-road trails;
a human machine interface (HMI) including one or more in-vehicle displays; and
a controller having one or more processors and a non-transitory computer-readable storage medium having a plurality of instructions stored thereon, which, when executed by the one or more processors, cause the one or more processors to perform operations comprising:
receive, by a user via the HMI, a navigational destination that includes a navigational route with an off-road trail;
receive, from the trail database via the vehicle communications system, information about the off-road trail;
receive, by the plurality of sensors, HV battery system data indicating status information of the HV battery system utilized to estimate a vehicle electric range;
determine vehicle operating conditions for traveling the off-road trail, based on the received trail database information;
prior to traversing the off-road trail, determine an estimated vehicle electric trail range based on the received trail database information and the received HV battery system data to thereby determine if the electrified vehicle has enough range to complete the off-road trail;
output, via the HMI, the estimated vehicle electric trail range; and
output a warning notification, via the HMI, when the estimated vehicle electric trail range is insufficient to enable the electrified vehicle to complete travel of the off-road trail, to thereby improve user confidence in deciding whether or not to travel the off-road trail.

2. The off-road TRE system of claim 1, wherein the received HV battery system data comprises:
a state of charge (SOC) of the HV battery system;
a state of health (SOH) of the HV battery system;
a temperature of the HV battery system; and
a capacity and voltage of the HV battery system.

3. The off-road TRE system of claim 1, wherein the received information from the trail database comprises:
a trail distance;
an estimated trail speed;
elevation changes of the off-road trail; and
grades of the off-road trail.

4. The off-road TRE system of claim 1, wherein the controller is further configured to:
receive, via the HMI, user input indicating trail conditions the user expects to encounter on the off-road trail,
wherein the determined estimated vehicle electric trail range is further based on the received user input.

5. The off-road TRE system of claim 1, wherein the controller is further configured to:
prior to traversing the off-road trail, prompt the user via the HMI for their intended vehicle cabin needs during travel on the off-road trail; and
receive, via the HMI, the user intended vehicle cabin needs,
wherein the determined estimated vehicle electric trail range is further based on the intended vehicle cabin needs.

6. The off-road TRE system of claim 5, wherein the intended vehicle cabin needs include:
whether or not an HVAC system of the electrified vehicle will be utilized during travel on the off-road trail; and
whether or not a vehicle roof will be removed during travel on the off-road trail.

7. The off-road TRE system of claim 1, wherein the controller is further configured to:
receive, by the plurality of sensors, vehicle data indicating status information of the electrified vehicle utilized to further estimate the vehicle electric range,
wherein the determined estimated vehicle electric trail range is further based on the received vehicle data.

8. The off-road TRE system of claim 7, wherein the received vehicle data includes:
a temperature of the electric motor;
a tire pressure of a plurality of wheels of the electrified vehicle;
electrical loads of one or more accessories of the electrified vehicle; and
propulsion system needs of the electrified vehicle based on a selected vehicle drive mode.

9. The off-road TRE system of claim 1, wherein the controller is further configured to:
receive historical drive cycle data,
wherein the determined estimated vehicle electric trail range is further based on the received historical drive cycle data.

10. (canceled)

11. The off-road TRE system of claim 1, wherein the controller is further configured to:
prior to traversing the off-road trail, determine a remaining range estimation for the electrified vehicle after travel on the off-road trail is complete;
determine if a vehicle charging location is within the determined remaining range estimation; and
output, via the HMI, a second warning notification to the user if the determined remaining range estimation is insufficient to enable the electrified vehicle to reach the vehicle charging location.

12. An off-road trail range estimation method for an electrified vehicle having an electrified powertrain including an electric motor powered by a high voltage (HV) battery system, a plurality of sensors configured to measure operating parameters of the electrified vehicle, a vehicle communications system configured to communicate with a trail database configured to store and analyze off-road trail data, and a human machine interface (HMI), and an off-road trail range estimation (TRE) system including a controller having one or more processors and a non-transitory computer-readable storage medium, the method comprising:
receiving, by the controller via the HMI, a navigational destination that includes a navigational route with an off-road trail;
receiving, by the controller and from the trail database, information about the off-road trail;
receiving, by the controller and the plurality of sensors, HV battery system data indicating status information of the HV battery system utilized to estimate a vehicle electric range;
determining, by the controller, vehicle operating conditions for traveling the off-road trail, based on the received trail database information;
prior to traversing the off-road trail, determining, by the controller, an estimated vehicle electric trail range based on the received trail database information and the received HV battery system data, to thereby determine if the electrified vehicle has enough range to complete the off-road trail;
outputting, via the HMI, the estimated vehicle electric trail range; and
outputting a warning notification, via the HMI, when the estimated vehicle electric trail range is insufficient to enable the electrified vehicle to complete travel of the off-road trail, to thereby improve user confidence in deciding whether or not to travel the off-road trail.

13. The method of claim 12, wherein the received HV battery system data comprises:
a state of charge (SOC) of the HV battery system;
a state of health (SOH) of the HV battery system;
a temperature of the HV battery system; and
a capacity and voltage of the HV battery system.

14. The method of claim 12, wherein the received information from the trail database comprises:
a trail distance;
an estimated trail speed;
elevation changes of the off-road trail; and
grades of the off-road trail.

15. The method of claim 12, further comprising:
receiving, by the controller and the HMI, user input indicating trail conditions the user expects to encounter on the off-road trail,
wherein the determined estimated vehicle electric trail range is further based on the received user input.

16. The method of claim 12, further comprising:
prior to traversing the off-road trail, prompting, by the controller and the HMI, a user for their intended vehicle cabin needs during travel on the off-road trail; and
receiving, via the HMI, the user intended vehicle cabin needs,
wherein the determined estimated vehicle electric trail range is further based on the intended vehicle cabin needs.

17. The method of claim 12, further comprising:
receiving, by the controller via the plurality of sensors, vehicle data indicating status information of the electrified vehicle utilized to further estimate the vehicle electric range,
wherein the determined estimated vehicle electric trail range is further based on the received vehicle data.

18. The method of claim 12, further comprising:
receiving, by the controller, historical drive cycle data,
wherein the determined estimated vehicle electric trail range is further based on the received historical drive cycle data.

19. (canceled)

20. The method of claim 12, further comprising:
prior to traversing the off-road trail, determining, by the controller, a remaining range estimation for the electrified vehicle after travel on the off-road trail is complete;
determining, by the controller, if a vehicle charging location is within the determined remaining range estimation; and
outputting, by the controller and the HMI, a second warning notification if the determined remaining range estimation is insufficient to enable the electrified vehicle to reach the vehicle charging location.

21. An electrified vehicle, comprising:
an electrified powertrain including at least one electric traction motor;
a high voltage (HV) battery system configured to power the at least one electric traction motor;
a plurality of sensors configured to measure operating parameters of the electrified vehicle including parameters of the HV battery system;
a vehicle communications system configured to communicate with a trail database configured to store and analyze data about off-road trails;
a human machine interface (HMI) including one or more in-vehicle displays; and
an off-road trail range estimation (TRE) system having a controller having one or more processors and a non-transitory computer-readable storage medium having a plurality of instructions stored thereon, which, when executed by the one or more processors, cause the one or more processors to perform operations comprising:
receive, by a user via the HMI, a navigational destination that includes a navigational route with an off-road trail;
receive, from the trail database via the vehicle communications system, information about the off-road trail;
receive, by the plurality of sensors, HV battery system data indicating status information of the HV battery system utilized to estimate a vehicle electric range;
determine vehicle operating conditions for traveling the off-road trail, based on the received trail database information;
prior to traversing the off-road trail, (i) determine an estimated vehicle electric trail range based on the received trail database information and the received HV battery system data, to thereby determine if the electrified vehicle has enough range to complete the off-road trail, (ii) determine a remaining range estimation for the electrified vehicle after travel on the off-road trail is complete, and (iii) determine if a vehicle charging location is within the determined remaining range estimation;
output, via the HMI, the estimated vehicle electric trail range;
output a first warning notification, via the HMI, when the estimated vehicle electric trail range is insufficient to enable the electrified vehicle to complete travel of the off-road trail; and
output a second warning notification, via the HMI, when the determined remaining range estimation is insufficient to enable the electrified vehicle to reach the vehicle charging location.

22. The electrified vehicle of claim 21, wherein the controller is further programmed to:
prior to traversing the off-road trail, query the user, via the HMI, whether or not a vehicle roof will be removed during travel on the off-road trail;
receive, via the HMI, user input of whether or not the vehicle roof will be removed during travel on the off-road trail,
wherein the determined estimated vehicle electric trail range is further based on whether or not the vehicle roof will be removed during travel on the off-road trail.
